(19) United States
(12) Patent Application Publication
(10) Pub. No.: US 2005/0232834 A1
(43) Pub. Date: Oct. 20, 2005

(54) Mitigation of top of catalyst bed fouling

(76) Inventors: Tahmid I. Mizan, Centreville, VA (US); Ramesh Gupta, Berkeley Heights, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 11/047,865

(22) Filed: Feb. 1, 2005

Related U.S. Application Data
(60) Provisional application No. 60/557,487, filed on Mar. 30, 2004.

(51) Int. Cl. B01J 8/02

(52) U.S. Cl. 422/220; 422/211; 422/217

(57) ABSTRACT

This invention relates to reactors with mitigation of fouling-related pressure buildup, the reactors having a reactor bed containing at least one catalyst layer through which reactants flow. The mitigation of fouling which occurs at the top of the reactor bed is accomplished by using at least one blowback ring located near the top of the reactor bed.

### CROSS-REFERENCE TO RELATED APPLICATION

This application claims benefit of U.S. Provisional Patent Application Ser. No. 60/557,487 filed Mar. 30, 2004.

### FIELD OF THE INVENTION

This invention relates to reactors having a reactor bed containing at least one catalyst layer through which reactants flow. More particularly, it relates to the mitigation of fouling which occurs at the top of the reactor bed by using at least one blowback ring located near the top of the reactor bed.

### BACKGROUND OF THE INVENTION

Reactors containing fixed catalyst beds typically experience pressure drop buildup due to catalyst fouling, particularly at the top of the catalyst bed. There are devices and reactor internals in use to mitigate top of the bed fouling, including bypass tubes, bed grading, scale baskets and scale traps. Top of the bed fouling can lead to high pressure drops which in turn can lead to premature shutdown of the reactor.

In commercial operations, the reactor is frequently opened to skim the catalyst bed top to remove the accumulated foulants. This practice is expensive because bed skimming necessitates reactor shutdown for a prolonged period of time. Dislodging of the accumulated foulants by periodically using reverse upward flow by a gas-liquid mixture introduced at the bottom of the reactor has also been discussed. However, there are several inherent risks of using periodic backward or backwash flow. The upward backwash flow can lead to lifting of the catalyst bed and fluidization of the catalyst particles. Bed lifting and fluidization can lead to breakage and deterioration of the catalyst particles in the bed. More importantly, the upflow can disrupt the integrity of the catalyst bed as the bed may not settle out uniformly after the upflow is ceased and the normal downflow is restarted. This will lead to flow channeling, non-uniform contacting with the catalyst, and hot spots.

It would be desirable to remove catalyst foulants, particularly those which accumulate at the top of the bed, without disturbing the catalyst bed itself.

### SUMMARY OF THE INVENTION

This invention relates to a reactor with mitigation of fouling, said reactor comprising:
(1) a reactor vessel having an inlet and an outlet;
(2) at least one bed of catalyst particles located within said reactor vessel;
(3) at least one top layer of inert particulate material or catalytically active particulate material adjacent to and on top of said at least one bed of catalyst particles provided that any catalytically active particulate material in the top layer can withstand jetting fluids;
(4) at least one blowback ring embedded within said top layer, said at least one blowback ring containing a plurality of jets for upwardly directing fluid passing through said at least one blowback ring.

In another embodiment, the invention relates to a process for mitigating fouling in a reactor, said process comprising:
(1) providing a reactor vessel having an inlet and an outlet;
(2) providing at least one bed of hydroprocessing catalyst particles located within said reactor vessel;
(3) providing at least one top layer of inert particulate material or catalytically active particulate material adjacent to and on top of said at least one bed of hydroprocessing catalyst particles provided that any catalytically active particulate material in the top layer can withstand jetting fluids;
(4) embedding at least one blowback ring within said top layer, said at least one blowback ring containing a plurality of jets for upwardly directing fluid passing through said at least one blowback ring;
(5) passing a feedstock through the reactor under hydroprocessing conditions; and
(6) passing fluids through the blowback ring jets at a velocity sufficient to dislodge any foulants that accumulate on or within the top layer.

The use of blowback or sparger rings embedded in the layer of inert material above the catalyst bed allows for removal of foulants which form at the top of the layer of inert material without disturbing the underlying catalyst bed. Periodic high velocity blow back fluid jets from the blowback ring are used to dislodge accumulated foulants thereby substantially eliminating pressure drop buildup that otherwise would otherwise necessitate reactor shutdown and loss of production.

### BRIEF DESCRIPTION OF THE DRAWINGS

FIG. 1 is a schematic view of a reactor according to the invention.

FIG. 2 is an enlarged top view of different embodiments of the blowback rings.

### DETAILED DESCRIPTION OF THE INVENTION

In an embodiment, this invention relates to reactors for carrying out catalytic reactions. A preferred use for the reactors relates to hydroprocessing reactions over at least one bed of hydroprocessing catalyst. By hydroprocessing is meant the contacting of a petroleum or chemical feedstock with hydrogen. Examples of hydroprocessing include hydrodesulfurization (HDS), hydrodenitrogenation (HDN), hydrotreating, hydrocracking, hydrofinishing, hydrofining, dewaxing, diene saturation or aromatic saturation. The petroleum feedstock can range from light feeds such as naphthas to heavy feeds such as resids. The nature of the catalyst will be a function of the particular type of hydroprocessing reaction. Examples of suitable catalyst for the various types of hydroprocessing include at least one metal from Groups 6, 8, 9 and 10 of the IUPAC Periodic Table format based on Groups 1-18 on an inorganic oxide support. Other catalyst may be based on molecular sieves containing at least one metal from Groups 6, 8, 9 and 10. Examples include intermediate pore and large pore zeolites and aluminum phosphates (SAPOs). Other catalysts include mesoporous materials such as those belonging to the M41S family of mesoporous materials as well as bulk metal catalysts containing bulk Groups 6, 8, 9 and 10 metals such as bulk Ni—W—Mo catalysts. By mesoporous is meant materials with pore openings between 40 and 100 Angstroms.

Hydroprocessing conditions are a function of the particular reaction desired. In general hydroprocessing conditions include temperatures of from 150 to 400° C., pressures of from 790 to 20,786 kPa (100 to 3000 psig), liquid hourly space velocities from 0.1 to 20 hr⁻¹ and hydrogen treat gas rates from 17.8 to 1780 m³/m³ (100 to 10,000 scf/B).

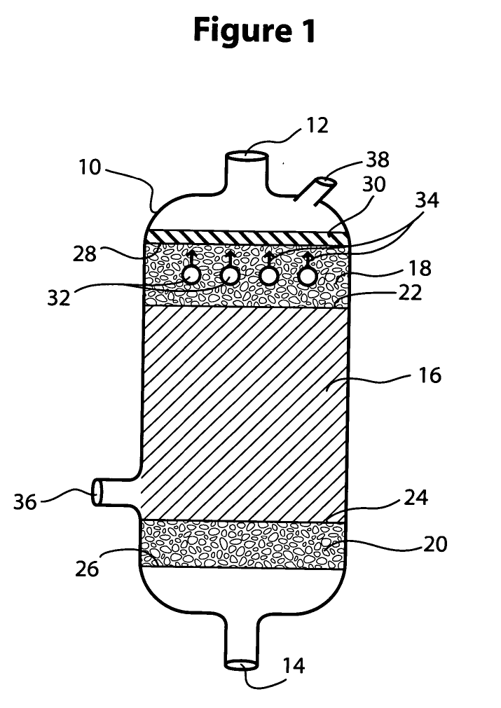

Referring now to FIG. 1, a reactor 10 contains an inlet 12 and an outlet 14 and a port 36 for adding or removing catalysts. An additional port 38 may be added to the reactor vessel above the level of the inert layer 18 in order to allow backwash fluid and foulant material to be removed from the reactor if necessary. Reactor 10 may have attached thereto conduits, pumps, heat exchangers, heaters, temperature controllers, compressors and the like which accompany hydroprocessing reactors but are not shown in FIG. 1. Located within reactor 10 is catalyst bed 16. The catalyst bed will contain catalyst particles that may be in any shape desired, e.g., spheres, trilobes, and the like. The catalyst particles may be in a single bed as shown in FIG. 1, or may be in layers in separate beds (not shown). The reactor vessel may contain one or more fluid distributors, quench boxes and other internals (not shown).

Located above and below the catalyst bed are beds of inert material 18 and 20, respectively. The inert material is usually in the form of ceramic or alumina balls. In one embodiment, the inert material is separated from the catalyst bed by separators or grates 22 and 24. The separators are typically perforated plates that allow passage of gases and liquids. The inert materials may be spherical or may be in any non-spherical shape desired, and may be solid, hollow, porous, or non-porous. The inert materials may be uniform in size or may be graded according to size, i.e., more than one layer of inert particles of different sizes may be used above or below the layer of catalyst. For example, in the case of spherical materials, the upper portion of the of an upper bed 18 of inert materials may comprise larger diameter spheres and layers of successively smaller spheres may lie beneath this layer of larger diameter spheres. The gradation may also be present in the lower bed 20 and may follow the same or reverse order of gradation of spheres, or the lower bed may contain inert materials of uniform size. The upper and lower beds of inert materials may contain support devices 26 and 28. The upper layer 18 may also comprise particles having at least some catalytic activity, provided that the catalytically active particles are robust and can maintain mechanical integrity during flow of fluids through blowback ring 32. The catalytically active particles may be mixed with inert particles. In general, the catalytically active particles in layer 18 are similar to the catalyst particles in the main bed except that these particles are preferably larger in size than the particles of the main bed. In addition to their larger size, these particles may have a lower concentration of metals to impart them a lower activity than the catalyst particles in the main bed itself. In operation, a layer of foulants 30 forms at or near the top of the top layer. This layer of foulants will gradually accrue during reactor use and results in pressure drops buildup across the reactor bed. This in turn leads to reduced efficiency of operation of the catalyst within the reactor.

According to the present invention, located within the layer of inert materials 18 are at least one blowback or sparger ring(s) 32. The blowback ring or rings have openings or nozzles 34 on top of said ring or rings for creating upwardly directed jets of fluids. The nozzles may also be inclined at an acute angle from the top of the ring or rings. These jets of fluids may loosen and remove the layer of foulants from the top of the reactor bed. It is preferred that the blowback rings be located towards the top of the layer of inert materials 18. Blowback ring or rings may also be located at or near the top of the catalyst layer 16 in case foulant material deposits on the top of the catalyst layer.

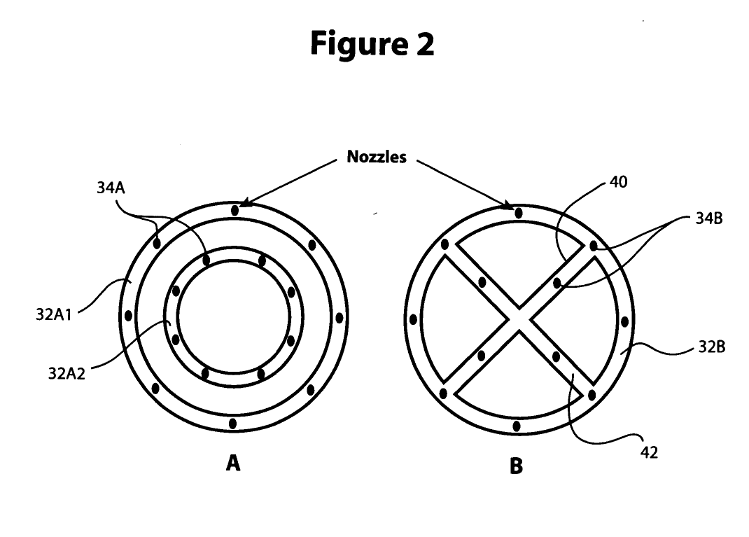

FIG. 2 shows two possible designs, A and B, for the blowback or sparger rings. Embodiment A illustrates a top view of two concentric blowback rings 32A1 and 32A2 located within the layer of inert material 18 in FIG. 1. The blowback rings contain nozzles 34 for upwardly directing at least one of a gas or liquid through the blowback rings. Examples of suitable gases and liquids include hydrogen, treat gas, nitrogen and light petroleum, including gases and liquids. The upwardly directed jets cause the at least one gas and liquid to contact the layer of foulants at the top of the reactor bed thereby removing the layer of foulants. It is preferred to use a two-phase gas/liquid fluid as the fluids blown through the blowback rings. Embodiment B shows a concentric blowback ring 32B. The inner wall of the concentric ring contains two interconnecting channels or cross members 40 and 42 in the shape of an “X”. Nozzles 34B are located on top for upwardly directing gas and/or liquid fluids that run through the blowback ring 32B and cross members 40 and 42.

With reference to FIG. 1, a petroleum feedstock is conducted to reactor 10 through inlet opening 12. Hydrogen or hydrogen-containing gas may enter reactor 10 co-currently through inlet 12 or may enter 10 countercurrently through inlet 14. The feedstock contacts the top of layer 18 of the heated reactor bed, flows downwardly through the layer of inert material 18 and then contacts the catalyst bed 16. Foulants 30 form at the top of the heated layer 18. These foulants can be dislodged using high velocity short bursts of gas, liquid or combination thereof which are directed to the foulants through nozzles 34 on top of the blowback rings 32. The gas(es), liquid(s) or combination thereof are conducted to the blowback ring(s) through conduits (not shown). It is preferred to use a high velocity two-phase gas-liquid mixture to dislodge foulants as the mixture provides a significantly higher shear for this purpose.

It is preferred that the high velocity blowback be used before the reactor pressure drop has built up to an unacceptable level. Generally, the blowback should be used before the pressure drop buildup due to fouling is less than about 35 kPA (5 psi). At much higher pressure, the foulants may crust and may become more difficult to dislodge.

The dislodged foulants may be allowed to remain as a loose aggregate on top of the reactor bed or may be withdrawn with the blowback fluid through nozzle 12 or port 38. The placement of the blowback rings in the layer of inert materials 18 allows the reactor to function without disturbance of the catalyst bed itself. Thus the reactor according to the invention allows the catalyst bed to function while minimizing pressure drops across the catalyst bed during operation.

Other configurations of blowback rings are possible and the designs illustrated in the drawings should not be construed as limiting. This invention may be applicable generally to other processes in which a fluid flows through a bed of catalyst which accumulates foulants on or near the top of the top layer.

1. A reactor with mitigation of fouling-related pressure buildup, said reactor comprising:
(1) a reactor vessel having an inlet and an outlet;
(2) at least one bed of catalyst particles located within said reactor vessel;
(3) at least one top layer of inert particulate material or catalytically active particulate material adjacent to and on top of said at least one bed of catalyst particles provided that any catalytically active particulate material in the top layer can withstand jetting fluids;
(4) at least one blowback ring embedded within said top layer, said at least one blowback ring containing a plurality of jets for upwardly directing fluid passing through said at least one blowback ring.

2. The reactor of claim 1 wherein the fluid in the blowback ring is at least one of gas or liquid.

3. The reactor of claim 2 wherein the fluid is a mixture of gas and liquid.

4. The reactor of claim 1 wherein the layer of inert particulate material is comprised of spheres.

5. The reactor of claim 4 wherein the spheres are graded according to at least one of size or shape.

6. The reactor of claim 1 wherein the layer of inert particulate material is non-spherical in shape.

7. The reactor of claims 4 or 6 wherein the inert particulate material is porous.

8. The reactor of claims 4 or 6 wherein the inert particulate material is non-porous.

9. The reactor of claim 6 wherein the inert particulate material is graded according to at least one of size or shape.

10. The reactor of claim 1 wherein the top layer is an inert particulate material.

11. A process for mitigating fouling in a reactor, said process comprising:
(a) providing a reactor vessel having an inlet and an outlet;
(b) providing at least one bed of hydroprocessing catalyst particles located within said reactor vessel;
(c) providing at least one top layer of inert particulate material or catalytically active particulate material adjacent to and on top of said at least one bed of hydroprocessing catalyst particles provided that any catalytically active particulate material in the top layer can withstand jetting fluids;
(d) embedding at least one blowback ring within said top layer, said at least one blowback ring containing a plurality of jets for upwardly directing fluid passing through said at least one blowback ring;
(e) passing a feedstock through the reactor under hydroprocessing conditions; and
(f) passing fluids through the blowback ring jets at a velocity sufficient to dislodge any foulants that accumulate on or within the top layer.

12. The process of claim 11 wherein the fluid in the blowback ring is at least one of gas or liquid.

13. The process of claim 11 wherein the fluid is a mixture of gas and liquid.

14. The process of claim 11 wherein the layer of inert particulate material is comprised of spheres.

15. The process of claim 14 wherein the spheres are graded according to at least one of size or shape.

16. The process of claim 11 wherein the layer of inert particulate material is non-spherical in shape.

17. The process of claim 16 wherein the inert particulate material is graded according to at least one of size or shape.

18. The process of claims 14 or 16 wherein the inert particulate material is porous.

19. The process of claims 14 or 16 wherein the inert particulate material is non-porous.

20. The process of claim 11 wherein hydroprocessing conditions include temperatures of from 150 to 400° C., pressures of from 790 to 20,786 kPa (100 to 3000 psig), liquid hourly space velocities from 0.1 to 20 hr⁻¹ and hydrogen treat gas rates from 17.8 to 1780 m³/m³ (100 to 10,000 scf/B).

21. The process of claim 11 wherein the fluids comprise hydrogen, treat gas, nitrogen and light petroleum gases, liquids or mixtures thereof.
